(19) United States
(12) Patent Application Publication
(10) Pub. No.: US 2007/0157377 A1
(43) Pub. Date: Jul. 12, 2007

(54) Turbo Jet

(76) Inventors: Thuy Xuan Mai, Houston, TX (US); William Bao Diep, Houston, TX (US)

Correspondence Address: DAVID ARTHUR WALKER, 20823 WHITEVINE WAY, KATY, TX, 77450, US

(21) Appl. No.: 11/326,660

(22) Filed: Jan. 7, 2006

(51) Int. Cl. A61H 33/04

(52) U.S. Cl. 4/541.6

(57) ABSTRACT

The present invention provides an apparatus, method and system for producing water flow within a pool or spa. A pump body contains a pump assembly with an impeller for aspirating water. A driving device connects to the impeller. A jet nozzle, which may be pivotable, directs water out of the pump. A front cover comprises a water intake inlet distal from ajet nozzle front cover opening. The front cover water intake inlet may be positioned to allow water flow into the apparatus substantially in a direction normal to water flow out of the apparatus. Impeller vanes may have angled front-side vane edges. Vanes may thicken with distance from the impeller center. A radius of curvature for an inside impeller vane surface may be less than a radius of curvature for an outside impeller vane surface. A radius of curvature for impeller vanes may decrease away from the impeller center.

### FIELD OF THE INVENTION

This invention relates to spas, pools, whirlpools or hot tubs and, more particularly, to water propulsion devices for salons and pools directing volumes of water and/or providing water under pressure to spa jets.

### BACKGROUND OF THE INVENTION

The use of water propulsion devices, such as water jets, in spas or hot tubs take water, put the water under pressure and convey the water to the various outlets or jets within a tub, pool or spa. The water under pressure creates a flow within the pool and discharges water so that it may have a pleasant and therapeutic effect on persons in the pool.

Many water flow devices for spas and pools have extensive plumbing that is difficult to clean. Bathwater may not completely drain from the plumbing. Instead, water may remain in a damp and dark environment where bacteria may breed. This water potentially includes soap film, hair, dirt, and anything other materials in the water. These materials may then be expelled from the pipes when the system is reactivated. This results in a potentially unsanitary environment.

U.S. Pat. No. 4,853,987 to Jaworski discloses a unitized hydrotherapy jet and pump assembly includes a housing having a mouth portion connected to and communicating through the wall of a hot tub, spa, bathtub, whirlpool or pool with the interior of the tub below the water line. In the mouth of the jet and pump assembly is a hydrotherapy jet nozzle outlet and a water inlet positioned adjacent to each other. A water pump within the assembly communicates between the water inlet and the jet outlet. A motor is connected to the pump to energize the pump for drawing water into the unit through the water inlet and expelling a stream of water back into the tub through the hydrotherapy jet.

U.S. Pat. Nos. 5,414,878 and 5,587,023 to Booth disclose a sanitary, cleanable, whirlpool jet apparatus having means for circulating water within a whirlpool without routing the whirlpool water through circulation piping.

U.S. Pat. No. 5,647,736 to French discloses a motor cooling technique for spas. A water jet circulation pump is fitted with a pump shroud having a collector portion for collecting exhaust from a pump vent and conducting the exhaust to an exhaust port. In one embodiment, the collector portion is U-shaped and fits over the motor venting and flush against a curved portion of the motor. Another embodiment includes a body portion comprising a cylinder open at one end and closed at an opposite end by an end face, the end face having an opening about which an exhaust port is formed.

U.S. Pat. No. 5,983,416 to Idland discloses a spa water delivery system, the spa includes a wall structure exposed to a water reception zone, and combination comprising: a water delivery structure associated with the wall structure to deliver water to the zone; a manually operable signaling device carried by the wall structure to be operated by a bather in the water reception zone; a sensor spaced from the signaling device to be out of contact with spa water, and responsive to operation of the signaling device to produce a control signal; whereby the control signal may be used to control a flow characteristic of water flowing via the delivery structure to the zone.

U.S. Pat. No. 6,030,180 to Clarey et al discloses an apparatus for generating water currents in a swimming pool in which an intake chamber, a discharge channel and a pump impeller are contained within a common housing. The discharge channel is defined within an open-ended discharge tube which extends longitudinally within the cylindrical housing. In use, the pump operates to suck water into the intake chamber around the tube through the front end of the housing. The water flows around the rear end of the discharge tube into the discharge chamber where it is expelled forcibly into the swimming pool through the discharge outlet at the open front end of the discharge tube. A pump stator member with radially extending guide vanes is provided in the discharge tube in front of the impeller to reduce swirling in the discharge channel. A safety guard may be provided over the inlet and the outlet at the front end of the housing.

U.S. Pat. No. 6,065,161 to Mateina et al discloses a device for producing a flow of fluid such as water or air in a whirlpool tub, having a rotatable impeller, which aspirates water from the space of the tub via intake openings, and ejects ajet of water or a jet of water and air into the space of the tub via outlet openings. The device further has a drive means for driving the impeller via a drive shaft. The driving means is arranged on the driving axle of the impeller but behind the impeller as viewed within the tub. In addition, the device further comprises a driving means such as a hydromotor, a pneumatic drive or a mechanical drive, that are driven by at least one central power drive, and can be serviced and repaired from within the whirlpool tub.

U.S. Pat. No. 6,671,531 to Toye discloses a water pump for a spa or the like that has a pump water inlet, a pump water outlet and an impeller driving water from said inlet to said outlet. The impeller provides the water axially introduced at the pump water inlet with a radial component which delivers the water to a large plenum chamber surrounding the impeller and which plenum chamber has an increasing cross sectional area as the water moves from the pump water inlet to a plenum chamber outlet thereby reducing backpressure in the water. The plenum chamber terminates with the plenum water outlet located closely to the impeller and a smooth transition area defines the area extending from the plenum chamber outlet to the pump water outlet. The water outlet preferably extends so that the water has a directional component which is generally parallel to the direction of the water entering the pump through the pump water inlet.

There is a need for an apparatus that efficiently moves water in and out of the pump apparatus. There is a need for a spa jet apparatus and system that provides for efficient and complete cleaning so that no water is left behind in the apparatus or system, and devices may be easily cleaned as often as desired. The is a need for an apparatus that provides for a water flow out of the device that does conflicting or interfering with water flowing in to the apparatus, thereby leading to a degraded or less than optimal performance of the apparatus and water flow in the pool environment.

### SUMMARY OF THE INVENTION

The present invention provides an apparatus, method and system for producing water flow within a pool or spa. A pump body contains a pump assembly with an impeller for aspirating water. A driving device like a DC or AC motor is connected to the impeller. A jet nozzle, which may be pivotable, directs impeller aspirated water out of the pump body. A front cover is attachable to the pump body. The front cover, which may be one piece, has a water intake inlet distal from a jet nozzle front cover opening. The jet nozzle front cover opening may be substantially in the center of the front cover. The front cover water intake inlet may be positioned to allow water flow into the apparatus substantially in a direction normal to the direction of the water flow out of the apparatus. The impeller vanes may have angled front-side vane edges. The vanes may thicken with distance from the impeller center. A radius of curvature for an inside impeller vane surface may be less than a radius of curvature for an outside impeller vane surface. A radius of curvature for impeller vanes may decrease away from the impeller center.

Examples of the more important features of the invention have been summarized (albeit rather broadly) in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE FIGURES

Objects and features of the present invention will become apparent from the following detailed description considered in connection with the accompanying drawings disclosing embodiments of the present invention. It should be understood, however, that the drawings are designed for the purpose of illustration only and not as a definition of the limits of the invention. In the drawings, wherein similar reference characters denote similar elements throughout the several views:

FIG. 1(a) illustrates an embodiment of a complete assembly of a Turbo Jet apparatus;

FIG. 1(b) illustrates a section through part of a Turbo Jet apparatus that may be installed in a spa or pool;

FIG. 2 illustrates various components of the present invention;

FIG. 3 illustrates an impeller provided by the present invention;

FIG. 4 further illustrates various components of the present invention;

FIG. 5 illustrates front covers provided by the present invention; and

FIG. 6 illustrates an exploded view with a subset of various components of the Turbo Jet invention.

While the invention will be described in connection with its preferred embodiments, it will be understood that the invention is not limited thereto. It is intended to cover all alternatives, modifications, and equivalents which may be included within the spirit and scope of the invention, as defined by the appended claims.

### DETAILED DESCRIPTION OF THE INVENTION

In view of the above, the present invention through one or more of its various aspects and/or embodiments is presented to provide one or more advantages, such as those noted below. The present invention provides for a turbo jet.

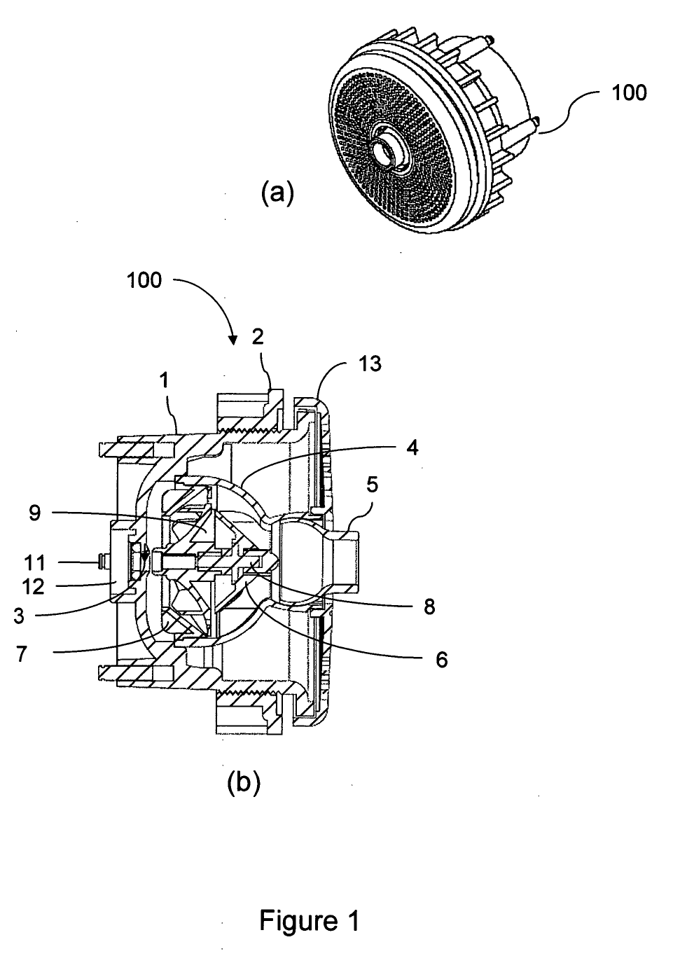

Turning now in detail to the drawings, FIG. 1(a) illustrates an embodiment of apparatus 100, the Turbo Jet, provided by the present invention. The Turbo Jet 100 produces a flow of water or a flow of water and air. The apparatus 100 is installed or attached to the wall of bathtub or pool, and may be attached through and/or attached to a wall opening formed to fit the apparatus. Optionally, a sleeve-like receptacle or housing for the apparatus 100 may be inserted in a wall or otherwise attached to a wall of a pool.

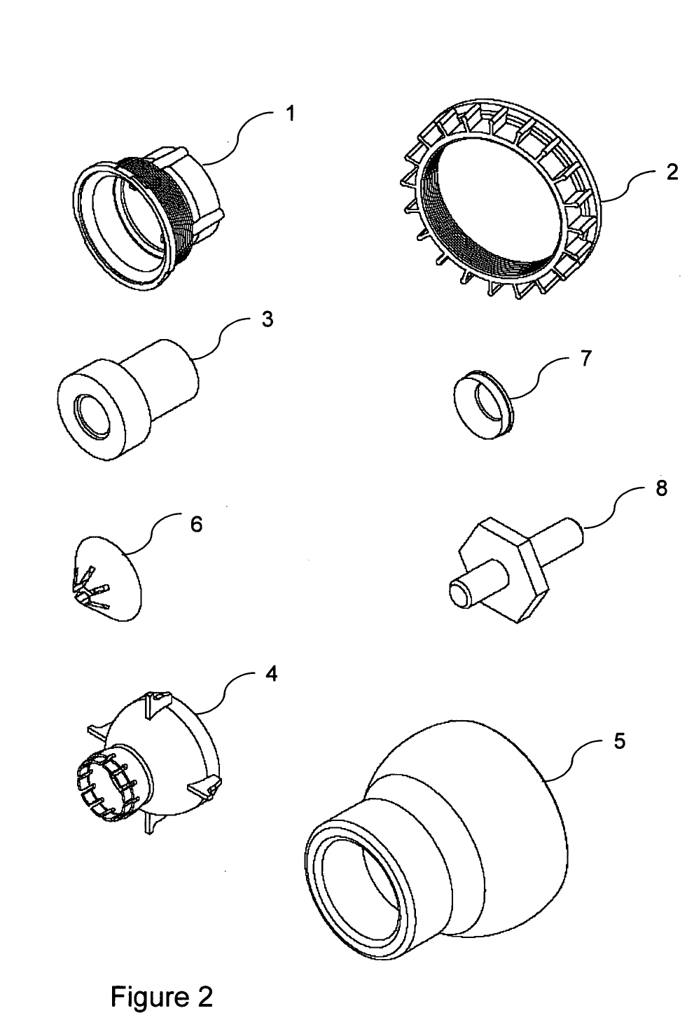

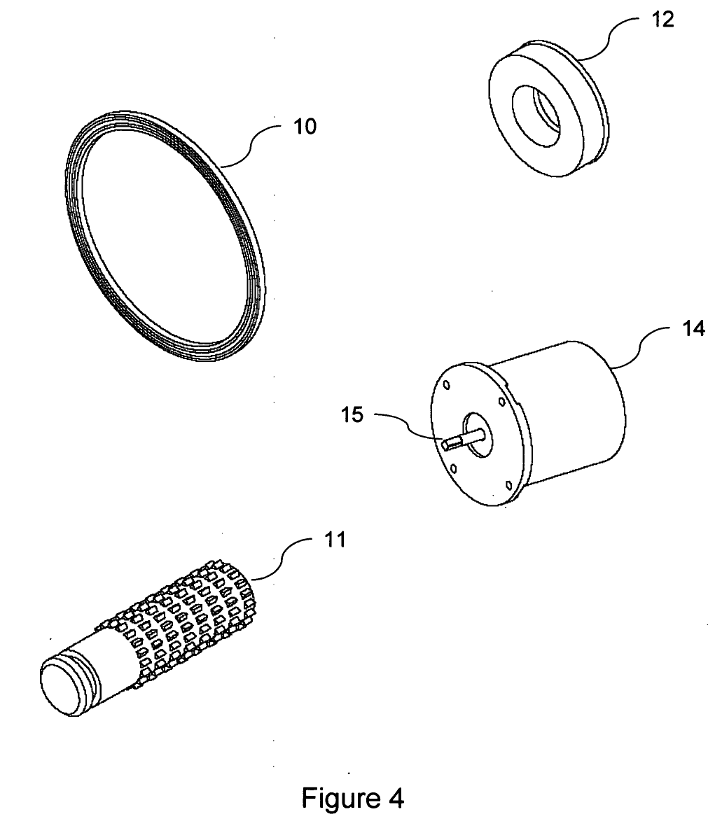

FIG. 1(b) illustrates an assembled embodiment of the present invention. The parts illustrated in FIG. 1(b), comprising a pump assembly housed in a pump body, are illustrated individually in FIG. 2 through FIG. 5. In the embodiment shown in FIG. 1(b), a power source like a motor (not shown) serves as the driving means or device for attaching to an impeller 9. A motor may be attached using one or more body pins 11. An impeller 9 may be driven by a motor device, for example Direct Current (DC) Motor 14 illustrated in FIG. 4. DC Motor 14 has a drive shaft 15 for attaching to impeller 9. Alternatively, an Alternating Current (AC) Motor may be used in place of DC Motor 14 or another drive source may be used.

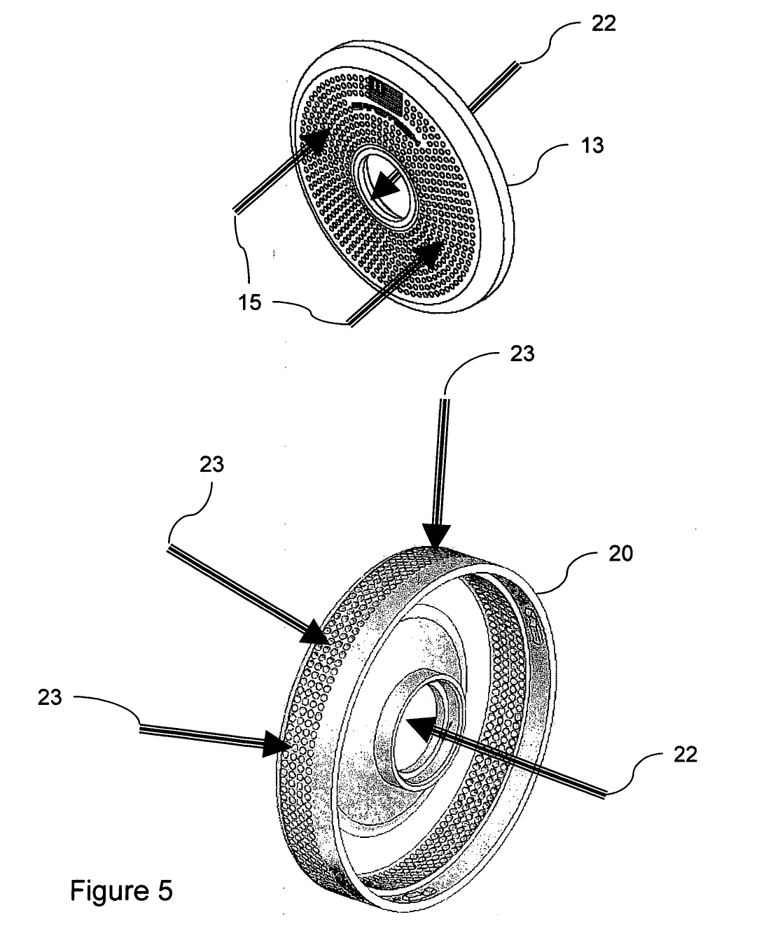

Impeller 9, mounted with the impeller's ‘back’ (e.g., a shroud for one side of the impeller) towards the pump body opening, is attached to impeller shaft 8 adjacent to mid part 6. Impeller shaft 8 is positioned between impeller 9 and mid-part 6. Impeller 9 rotates in a chamber, or volute, formed by jet holder 4 and middle back pump 7. Water flows into the pump body through openings in front cover 13 (see FIG. 5 for water flow direction relative to front cover 13, as well alternative front cover 20), traverses into the volute through middle back pump 7, and is aspirated by impeller 9 and moved towards jet nozzle 5. Jet holder 4 is also adjacent to an intake portion of front cover 13. Front cover 13 surrounds the proximal edge ofjet holder 4. Jet nozzle 5 may be pivotably mounted or supported in the proximal area of jet holder 4 and jet nozzle 5 may be adjusted to direct water/air flow in desired directions. The outside distal edge of front cover 13 rests tightly against the wall of a pool or spa. The direction of impeller rotation is selected so that impeller 9 aspirates water via intake openings of front cover 13 and causing water to eject through the jet nozzle 5.

FIG. 2 shows further examples of jet holder 4 and jet nozzle 5. As drawings of component parts are for illustration, a component part drawing may not be to scale relative to other components. FIG. 2 illustrates several components that comprise embodiments of the present invention. A pump body 1, which may be a housing or case for component parts of the apparatus 100, is provided. The pump body 1 is attachable to a wall of a pool or spa and may be secured to the wall of a spa or pool by the back nut 2. A wall gasket 10 (FIG. 4) may be positioned between the wall of spa or pool and back nut 2. FIG. 2 also further illustrates bushing 3, mid part 6, middle back pump 7 and impeller shaft 8.

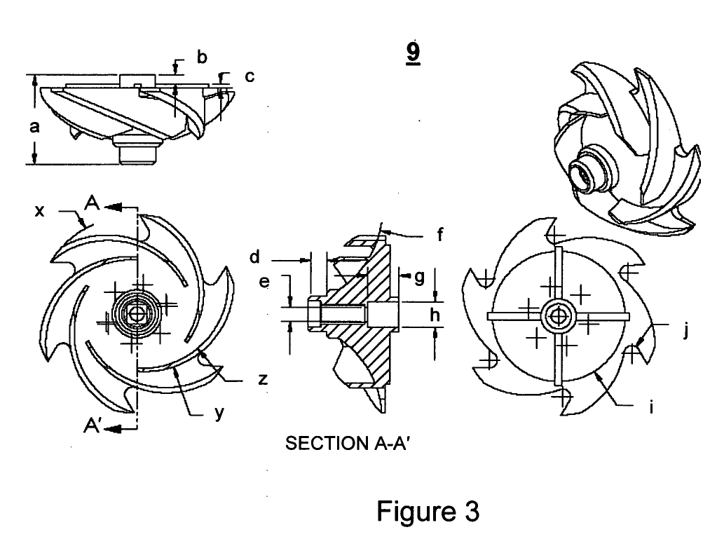

FIG. 3 schematically illustrates various views with exemplary variables for measurements of impeller 9 provided by the present invention. The various impeller measurements may be dependent on the size of the apparatus 100, and so no specific measurement sizes are specified herein. For example the measurement of the width from the front to back, a, is shown, and may be on the order of ten times extension distance b. Extension distance b on the back side of the impeller may be on the order of twice optional measurement c. The total radius of the impeller may be chosen as some radius x. The front side edges of the impeller vanes, directionally distal away from the impeller back or shroud, are shaped to facilitate efficient water movement toward the jet nozzle 5. For example, the impeller may have angled distal or front-side vane edges as illustrated in FIG. 3. In other words, the vane edges may be angled, for example, at 30° to 60° rather than having edges substantially normal to the inside or outside vane surfaces. Additionally, as illustrated in FIG. 3, the impeller vanes may become thicker as distance from the impeller center increases. One way to affect the thickness is for a radius of curvature to be less on the inside impeller vane surface (i.e., the vane surface closest to the impeller center), y, than on the outside impeller vane surface z. Therefore, the outside impeller vane edge vertical surface may have a radius of curvature less than the inside edge surface. The radius of curvature of the impeller vanes may decrease as distance from the impeller center increases.

A cross-section A-A′ is illustrated with examples of design measurement variables. Variables include a motor drive shaft, or body pin, opening width e, opening h with depth g, radius of curvature for vane edges f, and shaft length d. A view of the impeller's back or shroud includes variables for the radius of curvature j, which may be on the order of 10% of the radius of curvature x, and the radius of curvature i, which may be on the order of ⅔ of the radius of curvature of x.

FIG. 4 further illustrates several individual components that comprise embodiments of the present invention. An exemplary wall gasket 10 is illustrated, as well as a body pin 11, a ring gasket 12, and a DC Motor 14.

FIG. 5 illustrates a front cover 13, and an alternative front cover 20, which are both adaptable to fit with the present invention. These covers may comprise one contiguous piece. Front cover 13 contains a central hole to allow water flow out of jet nozzle 5. Surrounding and adjacent to the jet nozzle central hole are water input ports or openings to allow water to flow into apparatus 100. Water flow is shown relative to front cover 13 by input flow direction 15 and output flow 22. The direction of input flow 13 through the input openings and the output flow 22 that proceeds out of the water jet 5 are adjacent and in opposite directions, resulting in potential and/or actual conflict resulting in degradation of water flow in both directions 15 and 22. The potential or actual conflicting water flow may be exacerbated when the pivotably mounted jet nozzle 5 has been adjusted away from a direction normal to the face of front cover 13. Front cover 13 may be designed so that inlet water ports are not adjacent to the center of the front cover, but instead are distal from the center, and so present toward the outside of the front cover 13 circumference (not shown), so that less turbulence and degradation of water flow occurs during apparatus operation.

Alternative front cover 20 illustrated in FIG. 5 may be adapted to apparatus 100 in place of front cover 13, and is illustrated relative to input water flow 23 and output water flow 22. Alternative front cover 20 contains water input ports or openings that are distal from jet nozzle 5 so that these water input ports or openings are not adjacent to the jet nozzle 5. The input water flow 23 is normal to the front facing direction of apparatus 100 and therefore also normal or nearly normal to the flow of water expelled from jet nozzle 5. Water expelled from jet nozzle 5 flows in a direction normal or, depending on the position to which the pivotably mounted jet nozzle 5 has been adjusted, nearly or substantially normal to the input water flow 23. The direction of water flow 22 may change depending on the direction pivotably mounted jet nozzle 5 has been adjusted. Because the water input ports or openings, and therefore the input water flow is not adjacent to the jet nozzle 5, the direction of input flow 23 and output flow 22 are not in conflict, even when the pivotably mounted jet nozzle 5 has been arbitrarily adjusted. This results in more efficient flow of water both in and out of apparatus 100 than allowed by front cover 13. Because the jet nozzle 5 is not in proximity to the water inlet 20 openings, the pump of apparatus 100 operates more efficiently than when jet nozzle 5 is adjacent to water inlet openings.

Front cover 13 and alternative front cover 20 are illustrated with relatively small water input inlet openings. It will be appreciated that other larger water inlet openings, for example slotted and/or angled, may be employed to facilitate engineering design and manufacturing considerations. With larger water inlet openings, the front cover 13 and alternative front cover 20 may be fitted with screening or a screening device (not shown) to impede the ingress of foreign objects into apparatus 100 that may interfere with component part operations.

While front cover 13 and alternative front cover 20 are examples of front covers with jet nozzles directing water substantially through the center of the covers, other embodiments include directing water through a cover near an outside edge. These designs also allows for separating the input water flow from the output water flow in the vicinity of apparatus 100, thereby also reducing turbulence and facilitating water flow away from apparatus 100.

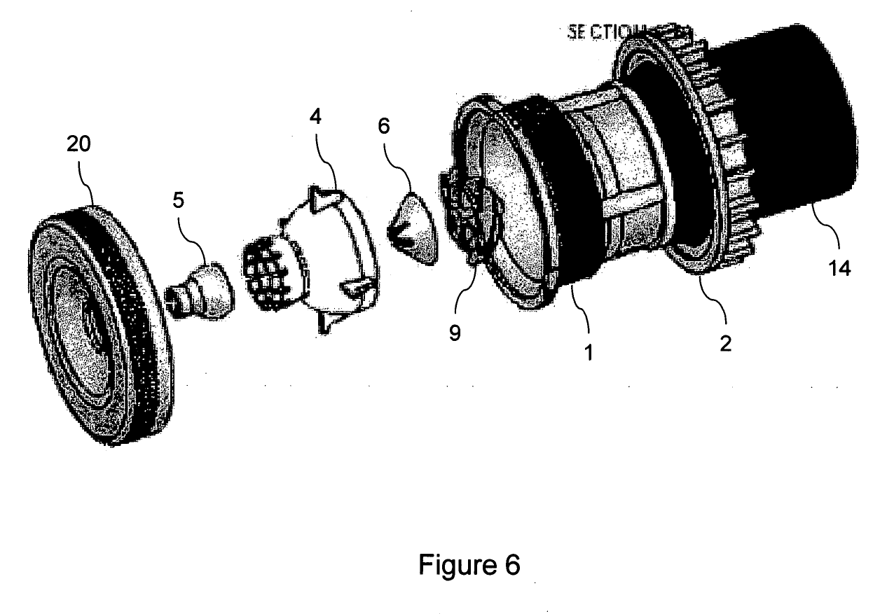

FIG. 6 illustrates an exploded view of an embodiment of apparatus 100 with alternate front cover 20 and a subset of the apparatus 100 component parts illustrated in FIG. 1 through FIG. 5. The parts not shown may be referred to in FIG. 1 through FIG. 5 if necessary for inclusion. A DC Motor 14 is provided, as are the pump body 1 and back nut 2, impeller 9, mid-part 6, jet-holder 4, jet nozzle 5 and alternate front cover 20.

Accordingly, while embodiments of the present invention have been shown and described, it is to be understood that many changes and modifications may be made thereunto without departing from the spirit and scope of the invention as defined in the appended claims. The present invention described herein is well adapted to carry out the objects and attain the ends and advantages mentioned, as well as others inherent therein. While various embodiments of the invention have been given for purposes of disclosure, numerous changes exist in the details of procedures for accomplishing the desired results. Various modifications will be apparent to those skilled in the art. It is intended that all variations within the scope and spirit of the appended claims be embraced by the foregoing disclosure.

What is claimed is:

1. An apparatus for producing fluid flow in a pool comprising:
(a) a pump body;
(b) an impeller for aspirating fluid in the pump body;
(c) an impeller driving device connected to the impeller;
(d) a jet nozzle for directing fluid aspirated by the impeller out of the pump body; and
(e) a front cover attachable to the pump body, the front cover having a fluid intake inlet for obtaining fluid from outside the pump body, the fluid intake inlet distal from a front cover opening for the jet nozzle and the fluid intake inlet further positioned to allow fluid flow into the apparatus in a direction substantially normal to the direction of the fluid flow out of the apparatus.

2. The apparatus of claim 1 wherein the front cover opening is substantially in the center of the front cover.

3. The apparatus of claim 1 wherein the front cover opening is substantially at the outside edge of the front cover.

4. The apparatus of claim 1 wherein the front cover is one piece.

5. The apparatus of claim 1 wherein the impeller driving device is at least one selected from the list consisting of i) a DC Motor, and ii) an AC Motor.

6. The apparatus of claim 1 wherein the jet nozzle is pivotable.

7. The apparatus of claim 1 wherein the impeller further comprises at least one selected from the list containing: i) angled distal vane edges; ii) impeller vanes that become thicker as distance from the impeller center increases; iii) a radius of curvature less on the inside impeller vane surface than on the outside impeller vane surface; and iv) a radius of curvature for impeller vanes that decreases as distance from impeller center increases.

8. An apparatus for producing water flow within a pool comprising:
(a) a pump body for holding a pump assembly;
(b) a pump assembly with an impeller for aspirating water in the pump body;
(c) an impeller driving device connected to the impeller;
(d) a jet nozzle for directing water aspirated by the impeller out of the pump body; and
(e) a front cover attachable to the pump body, the front cover comprising a water intake inlet for acquiring water from outside the pump body, the water intake inlet distal from a jet nozzle front cover opening.

9. The apparatus of claim 8 wherein the jet nozzle front cover opening is substantially in the center of the front cover.

10. The apparatus of claim 8 wherein the front cover is one piece.

11. The apparatus of claim 8 wherein the front cover water intake inlet is positioned to allow water flow into the apparatus substantially in a direction normal to the direction of the water flow out of the apparatus.

12. The apparatus of claim 8 wherein the impeller driving device is at least one selected from the list consisting of i) a DC Motor, and ii) an AC Motor.

13. The apparatus of claim 8 wherein the jet nozzle is pivotable.

14. The apparatus of claim 8 wherein the impeller further comprises at least one selected from the list containing: i) angled front-side vane edges; ii) impeller vanes that become thicker as distance from the impeller center increases; iii) a radius of curvature for an inside impeller vane surface that is less than a radius of curvature for an outside impeller vane. surface; and iv) a radius of curvature for impeller vanes that decreases as distance from impeller center increases.

15. An apparatus for producing water flow within a pool comprising:
(a) a pump body for holding a pump assembly;
(b) a pump assembly with an impeller for aspirating water out of the pump body through a jet nozzle, the impeller comprising vanes with curvature radii that decrease with distance from the impeller center;
(c) an impeller driving device connected to the impeller; and
(d) a front cover attachable to the pump body, the front cover comprising a water intake inlet for obtaining water from the pool, the water intake inlet distal from a front cover opening for the jet nozzle.

16. The apparatus of claim 15 wherein the front cover is one piece.

17. The apparatus of claim 15 wherein the front cover water intake inlet is positioned to allow water flow into the apparatus substantially in a direction normal to the direction of the water flow out of the apparatus.

18. The apparatus of claim 15 wherein the jet nozzle is pivotable.

19. The apparatus of claim 15 wherein the impeller driving device is at least one selected from the list consisting of i) a DC Motor, and ii) an AC Motor.

20. The apparatus of claim 15 wherein the impeller further comprises at least one selected from the list containing: i) angled front-side vane edges; ii) impeller vanes that become thicker as distance from the impeller center increases; and iii) a radius of curvature for an inside impeller vane surface that is less than a radius of curvature for an outside impeller vane surface.
